(19) United States
(12) Patent Application Publication
(10) Pub. No.: US 2026/0072812 A1
(43) Pub. Date: Mar. 12, 2026

(54) TEST SCRIPT CORRECTION APPARATUS, TEST SCRIPT CORRECTION METHOD AND PROGRAM

(71) Applicant: NIPPON TELEGRAPH AND TELEPHONE CORPORATION, Tokyo (JP)

(72) Inventors: Hiroyuki KIRINUKI, Tokyo (JP); Masaki TAJIMA, Tokyo (JP)

(73) Assignee: NIPPON TELEGRAPH AND TELEPHONE CORPORATION, Tokyo (JP)

(21) Appl. No.: 19/107,421

(22) PCT Filed: Sep. 6, 2022
(86) PCT No.: PCT/JP2022/033416

§ 371 Date: Feb. 27, 2025

(51) Int. Cl. G06F 11/3668; G06F 11/3698

(52) U.S. Cl. CPC G06F 11/368; G06F 11/3698

(57) ABSTRACT

A test script correction device includes: a search command extension unit that captures a certain screen element by using each of a plurality of locators designated in a source code of a test script regarding a screen of an application; and a locator correction unit that corrects the source code so as to replace, among the plurality of locators, a value of a first locator that has failed to capture the certain screen element with a value of an attribute corresponding to a type of the first locator in the certain screen element, thereby improving efficiency of dealing with the plurality of locators.

### TECHNICAL FIELD

The present invention relates to a test script correction device, a test script correction method, and a program.

### BACKGROUND ART

In automation of an end-to-end test involving a screen operation in a GUI application, a test script requires maintenance. In the test script, the test is automated by using a locator for specifying a screen element in order to operate a test target. The locator is generally defined by using attributes such as id and name of the screen element and structural information such as XPath.

When information used as the locator is changed due to correction of an application to be tested, the screen element cannot be captured by the existing locator in the test script. This is expressed as a locator being broken.

The locator being broken accounts for most of the factors requiring maintenance of the test script and is a barrier to automation of the test.

There has been conventionally proposed a method of using a plurality of locators to reduce labor of maintenance. By using a plurality of locators, in a case where a locator can correctly capture a screen element, but is partially broken, the broken locator can be automatically corrected by using information of a correct screen element (Non Patent Literature 1).

### CITATION LIST

### Non Patent Literature

Non Patent Literature 1: Leotta, M., A. Stocco, F. Ricca, and P. Tonella, “Using Multi-Locators to Increase the Robustness of Web Test Cases”, In 2015 IEEE 8th International Conference on Software Testing, Verification and Validation (ICST), 1-10, 2015

### SUMMARY OF INVENTION

### Technical Problem

There is no tool for the conventional method, and thus the conventional method needs to be manually performed. However, it is difficult to use a plurality of locators manually.

The present invention has been made in view of the above points, and an object thereof is to improve efficiency of dealing with a plurality of locators.

### Solution to Problem

Therefore, in order to solve the above problem, a test script correction device includes: a search command extension unit that captures a certain screen element by using each of a plurality of locators designated in a source code of a test script regarding a screen of an application; and a locator correction unit that corrects the source code so as to replace, among the plurality of locators, a value of a first locator that has failed to capture the certain screen element with a value of an attribute corresponding to a type of the first locator in the certain screen element.

### Advantageous Effects of Invention

It is possible to improve efficiency of dealing with a plurality of locators.

### BRIEF DESCRIPTION OF DRAWINGS

FIG. 1 shows a hardware configuration example of a test script correction device 10 according to an embodiment of the present invention.

FIG. 2 shows a functional configuration example of the test script correction device 10 according to the embodiment of the present invention.

FIG. 3 is a flowchart showing an example of a processing procedure executed by a search command extension unit 11 and a locator correction unit 12.

FIG. 4 is a flowchart showing an example of a processing procedure executed by a search command conversion unit 14.

FIG. 5 is a flowchart showing an example of a processing procedure executed by a locator rearrangement unit 13.

### DESCRIPTION OF EMBODIMENTS

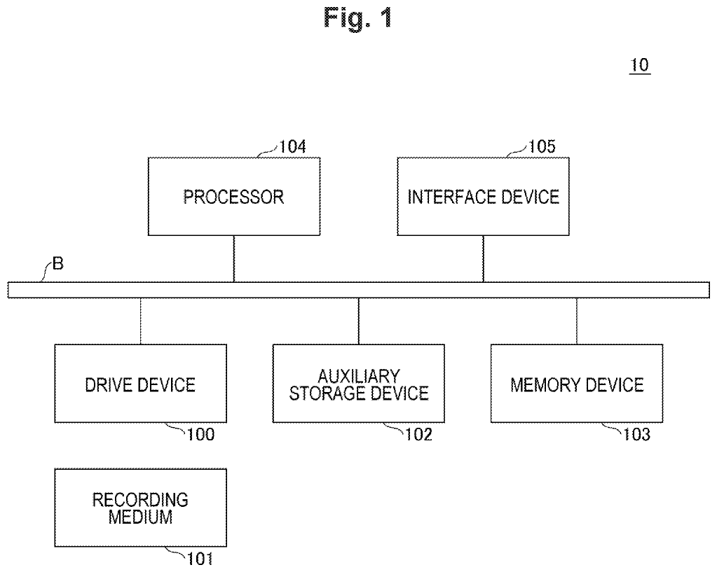

Hereinafter, embodiments of the present invention will be described with reference to the drawings. FIG. 1 shows a hardware configuration example of a test script correction device 10 according to an embodiment of the present invention. The test script correction device 10 in FIG. 1 includes a drive device 100, an auxiliary storage device 102, a memory device 103, a processor 104, an interface device 105, and the like which are connected to each other by a bus B.

A program that implements processing in the test script correction device 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores required files, data, and the like.

When a command to start the program is issued, the memory device 103 reads the program from the auxiliary storage device 102 and stores the program. The processor 104 is a CPU, a graphics processing unit (GPU), or a CPU and a GPU and executes a function related to the test script correction device 10 according to the program stored in the memory device 103. The interface device 105 is used as an interface for connection to the network.

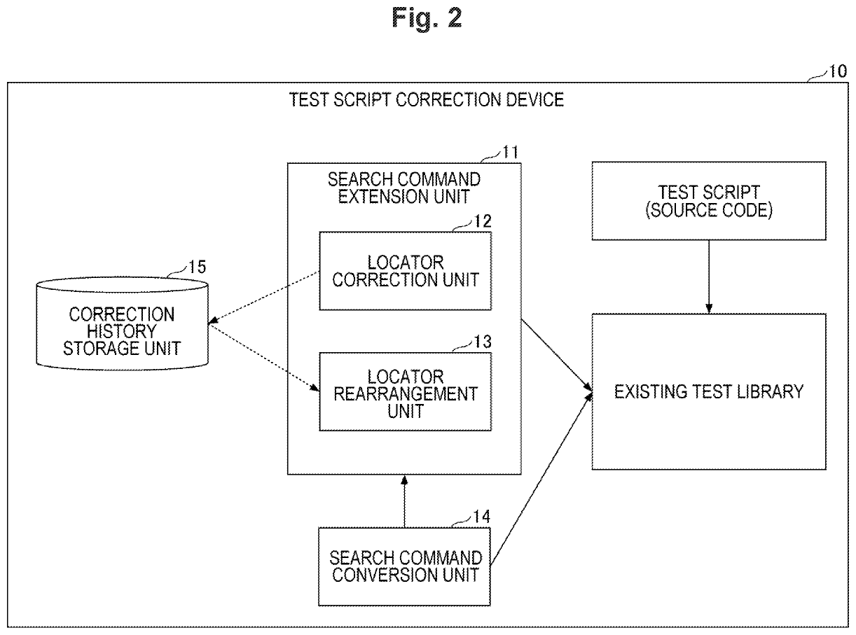

FIG. 2 shows a functional configuration example of the test script correction device 10 according to the embodiment of the present invention. In FIG. 2, the test script correction device 10 includes a search command extension unit 11, a locator correction unit 12, a locator rearrangement unit 13, and a search command conversion unit 14. Those units are implemented by processing that one or more programs installed in the test script correction device 10 cause the processor 104 to execute. The test script correction device 10 also uses a correction history storage unit 15. The correction history storage unit 15 can be implemented by using, for example, the auxiliary storage device 102 or a storage device connectable to the test script correction device 10 via a network.

### Search Command Extension Unit 11

The search command extension unit 11 extends an existing test library and provides a command (API) to search for one screen element in response to designation of a plurality of locators. The existing test library is an existing GUI test library called from a test script.

In a test for a web application or mobile application, a command to search for one specific (e.g. serving as a target to be operated) element from screen elements (hereinafter, simply referred to as “elements”) displayed on a screen being displayed for the test (e.g. a web page being displayed in a web browser) by using the existing test library is generally written in a source code of the test script. One locator is given as an argument of the command to search for the element (hereinafter, referred to as an “existing search command”). In a case where the element can be captured, the existing search command returns (an object of) the captured element. Note that, in the test script, an operation command or the like for the element can be executed by using (the object of) the returned element.

In the present embodiment, a unique command capable of giving a plurality of locators as the argument of the command to search for the element (hereinafter, referred to as an “extended search command”) is externally added to the existing test library.

A locator group has a priority order, and a locator earlier in a designated order of the locators for the extended search command has a higher priority.
Specifically, the extended search command searches for the element by using the locators one by one in order from the top of the designated locator group and returns the first captured element. Note that, for processing of searching for the element by using one locator in the extended search command, the existing search command is used as it is.

The locator includes a type k and a value vₖ, and an element whose attribute k has a value vₖ is searched for. An attribute group K (e.g. id, name, and XPath) that can be used as k is defined in advance. The symbol k is limited to being acquired and calculated from the element and the screen on which a test target is being displayed (e.g. web page).

For example, in a case where the existing test library is Selenium (registered trademark), the existing search command to search for an element whose id attribute has a value “password” in a certain web application can be written as follows.
driver.findElement({id: “password”});

In the present embodiment, it is possible to search for an element designating a plurality of locators by extending the existing test library and defining a unique command “findElementMulti” in the present embodiment as an extended search command having a function of the search command extension unit 11. An interface specification of “findElementMulti” is, for example, as follows.
driver.findElementMulti ({id:“password”},
{name:“password”},
{xpath:“/html/body/nav/div/ul/li[3]”});

This extended search command first searches for the element whose id attribute has a value “password”, and, in a case where the element cannot be captured, then searches for an element whose name attribute has a value “password”, and, in a case where the element still cannot be captured, then searches for an element whose XPath is
“/html/body/nav/div/ul/li[3]”.

Other GUI automated test libraries such as WebDriverIO are similarly extendable.

### Locator Correction Unit 12

During execution of the test script using the extended search command (findElementMulti), the locator correction unit 12 determines whether or not some of the plurality of locators designated in the extended search command in the source code of the test script are broken. When there is a broken locator, the locator correction unit 12 rewrites the source code to correct the locator. The locator correction unit 12 is implemented in the extended search command (findElementMulti). Therefore, it can be said that the extended search command (findElementMulti) includes the search command extension unit 11 and the locator correction unit 12.

### Search Command Conversion Unit 14

When the existing search command is called during execution of the test script using the existing search command, the search command conversion unit 14 automatically converts the existing search command into the extended search command (i.e. a command to search for one element in response to designation of a plurality of locators) provided by the search command extension unit 11. The search command conversion unit 14 is implemented in the existing search command (e.g. findElement). Therefore, in the present embodiment, the existing search command includes the search command conversion unit 14.

### Locator Rearrangement Unit 13

In a case where the locator captures an element other than a correct element in the extended search command, the test script operates the wrong element, and the test cannot be correctly executed. Therefore, it is necessary to preferentially use a locator that is hardly broken. Therefore, when the test script using the extended search command is executed, the locator rearrangement unit 13 rearranges the designated order of the plurality of locators designated in the extended search command in descending order of robustness of the locators. The robustness of the locators refers to unbreakability of the locators. Locators that are likely to be corrected mean that the locators are fragile. The locator rearrangement unit 13 is implemented in the extended search command (findElementMulti). Therefore, it can be said that the extended search command (findElementMulti) includes the search command extension unit 11, the locator correction unit 12, and the locator rearrangement unit 13.

### Processing Procedure

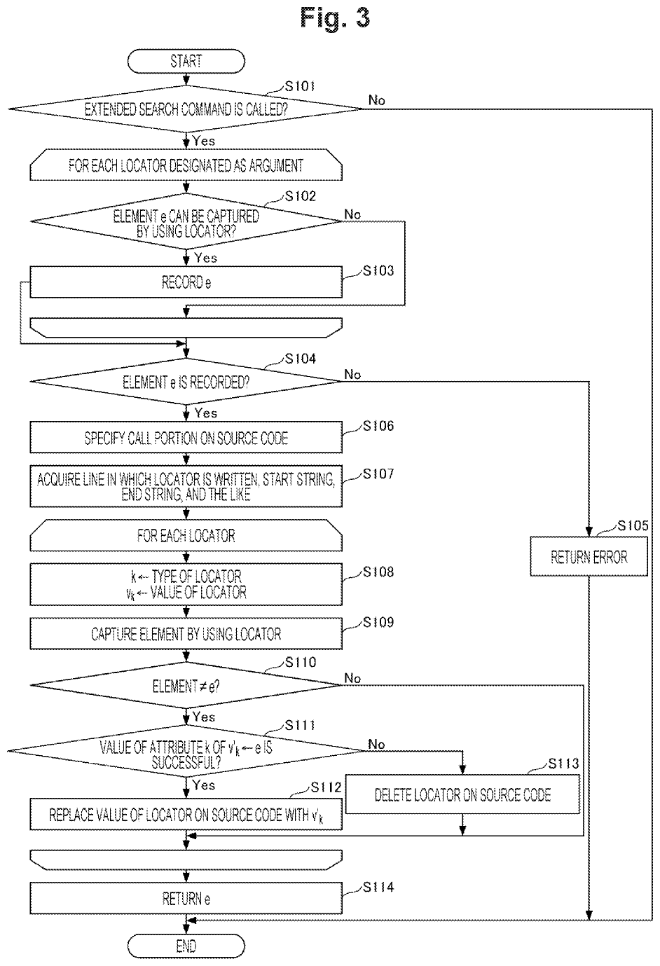

Hereinafter, a processing procedure related to each unit will be described. FIG. 3 is a flowchart showing an example of a processing procedure executed by the search command extension unit 11 and the locator correction unit 12.

When an extended search command (findElementMulti) is called from a test script during execution of a test (Yes in S101), a processing procedure in and after step S102 is executed in the extended search command, The search command extension unit 11 executes loop processing including steps S102 and S103 for each locator designated as an argument. The locator to be processed in the loop processing will be referred to as a “target locator”. Each locator serves as the target locator in the order designated as the argument.

In step S102, the search command extension unit 11 designates the target locator as the argument and calls an existing search command (e.g. findElement) to determine whether or not (an object of) an element can be captured from a currently displayed screen (e.g. web page). If an element cannot be captured (No in S102), a locator designated as the next target locator is set as the target locator, and the loop processing is executed.

If an element can be captured (Yes in S102), the search command extension unit 11 records the captured element as a correct element e in the memory device 103 (S103) and ends the loop processing. That is, an element is sequentially searched for in a plurality of locators, and an element that can be captured first is recorded as the correct element e.

After step S103 or when the loop processing ends, the search command extension unit 11 determines whether or not the element e is recorded in the memory device 103 (i.e. whether or not the element e has been captured by any locator) (S104). If the element e is not recorded in the memory device 103 (No in S104), the search command extension unit 11 returns an error to the test script serving as a caller of the extended search command (S105).

If the element e is recorded in the memory device 103 (Yes in S104), the locator correction unit 12 specifies a call portion of the called extended search command on a source code of the test script (S106). Specifically, the locator correction unit 12 analyzes a stack trace of the program and acquires a path name of a file including the call portion of the extended search command in a file group constituting the test script and a line number of the portion in the file.

Then, the locator correction unit 12 performs parsing for a line of the line number of the file and thus acquires, for each locator designated in the extended search command, a line number in which the locator is written, a type and value of the locator, and a start string (from which character) and end string (up to which character) of the locator (S107).

Parsing is performed on the premise that, for example, an extended search command that can designate N locators as an argument is written in the following format. In the present embodiment, the following <extended search command name>is “findElementMulti”.

<extended search command name>( {type 1: value 1}, {type 2: value 2}, . . . , {type N: value N})

Then, the locator correction unit 12 executes loop processing including steps S108 to S113 for each of all the locators designated by the extended search command. The locator to be processed in the loop processing will be referred to as a “target locator”.

In step S108, the locator correction unit 12 substitutes the type of the target locator (e.g. id, name, and XPath) for a variable k and substitutes the value of the target locator for a variable vₖ.

Then, the locator correction unit 12 designates the target locator as the argument and calls the existing search command (e.g. findElement) to attempt to capture (an object of) an element corresponding to the target locator from a currently displayed screen (e.g. web page) (S109).

If an element cannot be acquired by the target locator, or if an element captured by the target locator (hereinafter, referred to as a “captured element”) is different from the element e (Yes in S110), the target locator is broken. Therefore, in this case, the locator correction unit 12 executes processing for correcting the target locator in steps S111 to S113.

In step S111, the locator correction unit 12 attempts to acquire a value v′ₖ of the attribute k from the element e. When the locator correction unit 12 can acquire the value v′ₖ (i.e. when the element e has the attribute k) (Yes in S111), the locator correction unit corrects (rewrites) the source code of the test script so as to replace a portion of the value vₖ of the target locator specified on the basis of the information acquired in step S107 with v′ₖ on the source code (S112). When the locator correction unit 12 cannot acquire the value v′ₖ (i.e. when the element e does not have the attribute k) (No in S111), the locator correction unit corrects (rewrites) the source code of the test script so as to delete the target locator from a position specified on the basis of the information in step S107 on the source code (S113).

The above correction is executed with respect to all the called extended search commands, and thus all broken locators are corrected.

For example, the value of the id attribute is changed to “new-password”, and the name attribute is deleted for an element that has been searched for by using the following extended search command. Meanwhile, XPath is not changed.
driver.findElementMulti({id: “password”},
{name:“password”},
{xpath:“/html/body/nav/div/ul/li[3]”});

XPath is not changed, and a correct element can be captured by a locator
{xpath:“/html/body/nav/div/ul/li[3]”}.

In this case, the correct element cannot be captured by {id:“password”} and {name:“password”} , and thus those two locators are determined as broken locators. Meanwhile, the element can be captured by the locator {xpath:“/html/body/nav/div/ul/li[3]”}, and thus the element is determined as the correct element e. The value of the id attribute can be acquired from the element e, and the value is defined as “new-password”. Further, the value of the name attribute cannot be acquired from the element In this case, the locator correction unit 12 corrects the extended search command as follows.
driver.findElementMulti ({id:“new-password”},
{xpath:“/html/body/nav/div/ul/li[3]”});

That is, the value of the locator whose type is id is changed to “new-password”, and the locator whose type is name is deleted.

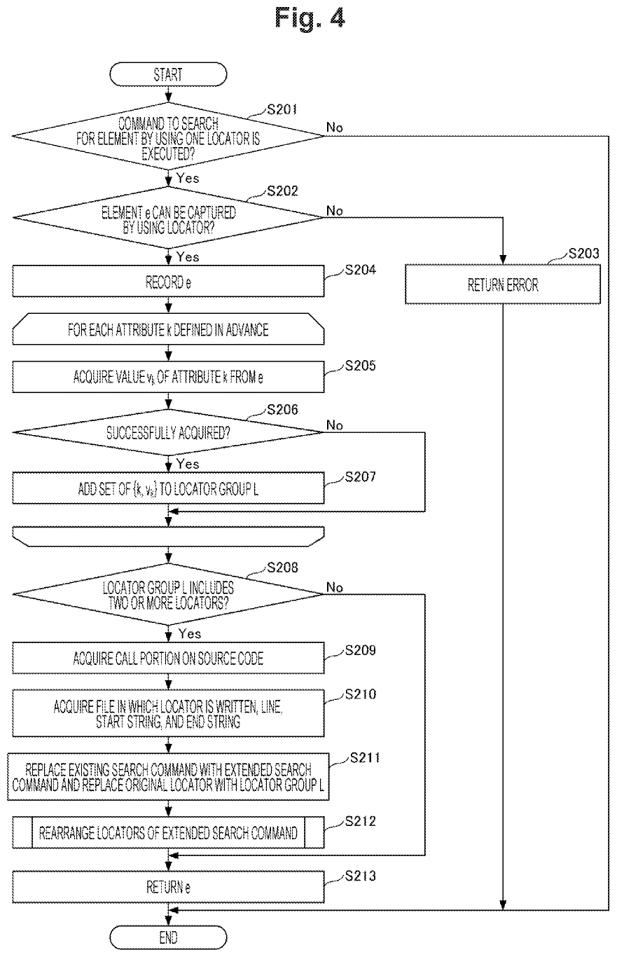

FIG. 4 is a flowchart showing an example of a processing procedure executed by the search command conversion unit 14.

When an existing search command (e.g. findElement) is called from a test script during execution of a test (Yes in S201), a processing procedure in and after step S202 is executed in the existing search command.

In step S202, the search command conversion unit 14 designates a target locator as an argument and executes existing implementation of the existing search command (e.g. findElement) to determine whether or not (an object of) an element e corresponding to the locator designated as the argument of the existing search command can be captured from a currently displayed screen (e.g. web page). If the element e cannot be acquired (No in S202), the search command conversion unit 14 returns an error to the test script serving as a caller of the existing search command (S203).

If the element e can be captured (Yes in S202), the search command extension unit 11 records the element e in the memory device 103 (S204).

Then, the search command conversion unit 14 executes loop processing including steps S205 to S207 for each of a plurality of attributes k included in an attribute group K defined in advance. The attribute k to be processed in the loop processing will be referred to as a “target attribute k”. For example, the attribute group K is a set of attributes that can be used as a locator. Alternatively, the attribute group K may be a set of attributes that can uniquely specify the element e among attributes of the element e. In this case, the attribute group K may be determined by the search command conversion unit 14 at this timing, instead of being defined in advance.

In step S205, the search command conversion unit 14 acquires the value vₖ of the target attribute k from the element e. When the value vₖ of the target attribute k is successfully acquired (i.e. if the element e has the target attribute k) (Yes in S206), the search command conversion unit 14 adds a set of the target attribute k and its value vₖ to a locator group L as a locator of the type k and the value vₖ (S207). The locator group L is, for example, a list structure data capable of storing one or more locators. When the value vi of the target attribute k is unsuccessfully acquired (i.e. when the element e does not have the target attribute k) (No in S206), step S207 is not executed. Therefore, in the loop processing, a locator corresponding to the attribute k usable as a locator and its value vₖ in the attribute group K is stored in the locator group L. For example, in a case where {k₁, k₂, . . . , kₙ}∈K exists in the element e, n locators are stored in the locator group L.

When the loop processing is executed for all the attributes k included in the attribute group K, the search command conversion unit 14 determines whether or not the locator group L includes two or more locators (S208). When the locator group L does not include two or more locators (No in S208), steps S209 to S212 are not executed, and the processing proceeds to step S213.

When the locator group L includes two or more locators (Yes in S208), in subsequent steps S209 and S210, the search command conversion unit 14 acquires a path name of a file including a call portion of the called existing search command, a line number of the portion in the file, a type and value of a locator designated in the existing search command, and a start string (from which character) and end string (up to which character) of the locator by processing similar to steps S106 and S107 of FIG. 3.

Then, the search command conversion unit 14 replaces the called existing search command with an extended search command (findElementMulti) and rewrites the call portion of the existing search command in the source code of the test script such that each locator included in the locator group I is designated for the replaced extended search command (i.e. such that the original locator is replaced with the locator group L) (S211). Note that a written position of the original locator can be specified from the information acquired in step S210.

Then, the search command conversion unit 14 requests the locator rearrangement unit 13 to rearrange a designated order of the locators of each extended search command called from the test script (S212). As a result, the designated order of the locators rewritten in step S211 can also be corrected on the basis of robustness. Then, the processing proceeds to step S213. Note that step S212 may not be executed at this timing. For example, the locator rearrangement unit 13 may be called at a timing designated by a user after the test ends.

In step S213, the search command conversion unit 14 returns the element e to the test script serving as a caller of the existing search command.

For example, the called existing search command is as follows.
driver.findElement({id:“password”});

The element e has the name attribute and an XPath attribute in addition to the id attribute. In this case, in a case where the priority order of those attributes is as follows: id, name, and XPath, the above existing search command is rewritten as follows.
driver.findElementMulti({id:“password”},
{name:“password”},
{xpath:“/html/body/nav/div/ul/li[3]”});

Note that XPath cannot be acquired only from the element e, but can be calculated from the element e and the screen to be tested.

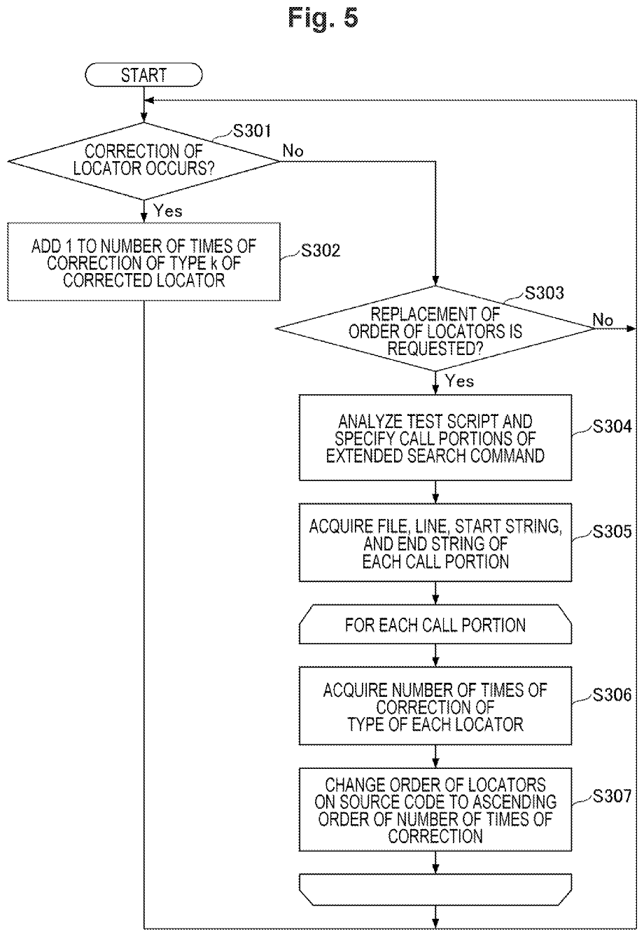

FIG. 5 is a flowchart showing an example of a processing procedure executed by the locator rearrangement unit 13.

When step S112 or S113 in FIG. 3 is executed and one locator of the extended search command is corrected (Yes in S301), the locator rearrangement unit 13 adds 1 to the number of times of correction pk of the type k of the corrected locator (S302). That is, step S302 is executed in step S112 or S113 of FIG. 3. The number of times of correction for each type of the locator is stored in the correction history storage unit 15, and an initial value thereof is 0, In the present embodiment, a tendency for the locator to be corrected (fragility) is defined by the number of times of correction.

Meanwhile, when replacement of the order of the locators is requested in step S212 of FIG. 4 or at an arbitrary timing of the user (Yes in S303), the locator rearrangement unit 13 specifies all portions calling the extended search command in the source code of the test script (S304). In the present embodiment, the portions can be specified on the basis of a character string search of “findElementMulti”.

Then, the locator rearrangement unit 13 acquires, for each of the specified portions, a line number in which the locator is written in a file including the portion, a type and value of the locator, and a start string (from which character) and end string (up to which character) of the locator by processing similar to step S107 (S305).

Then, the locator rearrangement unit 13 executes loop processing including steps 8306 and S307 for each call portion specified in step S304.

In step S306, the locator rearrangement unit 13 acquires, from the correction history storage unit 15, the number of times of correction pk regarding the type k of each locator designated in the call portion to be processed (hereinafter, referred to as a “target call portion”).

Then, the locator rearrangement unit 13 changes (corrects) the target call portions such that a designated order of the locators in the target call portions is in the ascending order of the number of times of correction pr (S307).

In a case where the types of the locators designated in the target call portions are types k₁ to kₙ, and a magnitude relationship between the numbers of times of correction pk thereof is pₖ₁>pₖ₂> . . . >pₖₙ due to correction of the locators performed a plurality of times in the past, the locator rearrangement unit 13 changes the order of the locators such that the locators are designated in the following order: [kₙ, . . . , k₂, k₁].

For example, after a plurality of times of execution of the test script (i.e. execution of the processing procedure in FIG. 4), the number of times of correction of the locator using id is ten times, the number of times of correction of the locator using name is seven times, and the number of times of correction of the locator using XPath is eight times.

In this case, the following extended search command:
driver.findElementMulti({id:“password”},
{name:“password”},
{xpath:“/html/body/nav/div/ul/li[3]”});

can be rewritten as follows.
driver.findElementMulti{name:“password”},
{xpath:“/html/body/nav/div/ul/li[3]”},
{id:“password”});

As a result, the extended search command can search for the element by preferentially using a more robust locator. This makes it possible to increase a possibility that the element captured by the extended search command is an element intended by the user.

As described above, according to the present embodiment, a broken locator among a plurality of locators can be automatically corrected. Therefore, it is possible to improve efficiency of dealing with a plurality of locators. For example, it is possible to reduce labor for maintenance of the plurality of locators.

Further, an existing search command in a test script can be automatically converted into an extended search command. Therefore, it is possible to improve efficiency of dealing with the plurality of locators. For example, it is possible to reduce labor for implementing the plurality of locators.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Test script correction device
11 Search command extension unit
12 Locator correction unit
13 Locator rearrangement unit
14 Search command conversion unit
15 Correction history storage unit
100 Drive device
101 Recording medium
102 Auxiliary storage device
103 Memory device
104 Processor
105 Interface device
B Bus

1. A test script correction device comprising:
a search command extension circuitry that captures a certain screen element by using each of a plurality of locators designated in a source code of a test script regarding a screen of an application; and
a locator correction circuitry that corrects the source code so as to replace, among the plurality of locators, a value of a first locator that has failed to capture the certain screen element with a value of an attribute corresponding to a type of the first locator in the certain screen element.

2. The test script correction device according to claim 1, wherein
in a case where the first locator can capture a screen element different from the certain screen element, and the certain screen element has the attribute corresponding to the type of the first locator, the locator correction unit rewrites the value of the first locator to the value of the attribute.

3. The test script correction device according to claim 1, wherein
in a case where the first locator can capture a screen element different from the certain screen element, and the certain screen element does not have the attribute corresponding to the type of the first locator, the locator correction unit deletes the first locator from the source code.

4. The test script correction device according to claim 1, wherein
the search command extension circuitry captures the screen element by using the plurality of locators in an order designated in the source code, and
the locator correction circuitry rewrites the source code so as to replace the value of the first locator with the value of the attribute corresponding to the type of the first locator in a screen element that is captured first.

5. The test script correction device according to claim 4, comprising
locator rearrangement circuitry that records, for each type of the locator, the number of times the value has been rewritten by the locator correction circuitry and changes the order of the plurality of locators designated in the source code to an ascending order of the number of times regarding the plurality of locators.

6. A test script correction method, wherein
computer executes
search command extension procedure of capturing a certain screen element by using each of a plurality of locators designated in a source code of a test script regarding a screen of an application, and
locator correction procedure of correcting the source code so as to replace, among the plurality of locators, a value of a first locator that has failed to capture the certain screen element with a value of an attribute corresponding to a type of the first locator in the certain screen element.

7. A computer-readable non-transitory recording medium storing computer-executable program instructions that when executed by a processor cause a computer to execute a test script correction program causing:
search command extension procedure of capturing a certain screen element by using each of a plurality of locators designated in a source code of a test script regarding a screen of an application; and
a locator correction procedure of correcting the source code so as to replace, among the plurality of locators, a value of a first locator that has failed to capture the certain screen element with a value of an attribute corresponding to a type of the first locator in the certain screen element.

8. The test script correction method according to claim 6, wherein
in a case where the first locator can capture a screen element different from the certain screen element, and the certain screen element has the attribute corresponding to the type of the first locator, the locator correction unit rewrites the value of the first locator to the value of the attribute.

9. The test script correction method according to claim 6, wherein
in a case where the first locator can capture a screen element different from the certain screen element, and the certain screen element does not have the attribute corresponding to the type of the first locator, the locator correction unit deletes the first locator from the source code.

10. The test script correction method according to claim 6, wherein
the screen element is captured by using the plurality of locators in an order designated in the source code, and
the source code is rewritten so as to replace the value of the first locator with the value of the attribute corresponding to the type of the first locator in a screen element that is captured first.

11. The test script correction method according to claim 10, comprising:
for each type of the locator, the number of times the value has been rewritten is recorded and changes the order of the plurality of locators designated in the source code to an ascending order of the number of times regarding the plurality of locators.

12. The computer-readable non-transitory recording medium according to claim 7 wherein the test script correction method further comprises:
in a case where the first locator can capture a screen element different from the certain screen element, and the certain screen element has the attribute corresponding to the type of the first locator, the locator correction unit rewrites the value of the first locator to the value of the attribute.

13. The computer-readable non-transitory recording medium according to claim 7 wherein the test script correction method further comprises:
in a case where the first locator can capture a screen element different from the certain screen element, and the certain screen element does not have the attribute corresponding to the type of the first locator, the locator correction unit deletes the first locator from the source code.

14. The computer-readable non-transitory recording medium according to claim 7 wherein the test script correction method further comprises:
the screen element is captured by using the plurality of locators in an order designated in the source code, and
the source code is rewritten so as to replace the value of the first locator with the value of the attribute corresponding to the type of the first locator in a screen element that is captured first.

15. The computer-readable non-transitory recording medium according to claim 14 wherein the test script correction method further comprises:
for each type of the locator, the number of times the value has been rewritten is recorded and changes the order of the plurality of locators designated in the source code to an ascending order of the number of times regarding the plurality of locators.

16. The test script correction device according to claim 1, wherein a modification history storage stores a number of modifications for each type of the plurality of locators and susceptibility to modification of the plurality of locators is defined by the number of modifications.

17. The test script correction device according to claim 5, wherein the locator rearrangement circuitry inserts an extended search command to the source code of the test script upon receiving a user request to change the order of the plurality of locators.

18. The test script correction device according to claim 16, wherein the locator rearrangement circuitry acquires the number of modifications for each type of the plurality of locators specified in a calling location and changes a target call location in ascending order of the number of modifications.

19. The test script correction method according to claim 6, wherein a number of modifications is stored for each type of the plurality of locators and susceptibility to modification of the plurality of locators is defined by the number of modifications.

20. The test script correction method according to claim 19, wherein an extended search command is inserted to the source code of the test script upon receiving a user request to change the order of the plurality of locators.
